(19) United States
(12) Patent Application Publication
(10) Pub. No.: US 2004/0153226 A1
(43) Pub. Date: Aug. 5, 2004

(54) Vehicle suspension control system

(75) Inventor: Xubin Song, Canton, MI (US)

Correspondence Address: VISTEON, C/O BRINKS HOFER GILSON & LIONE, PO BOX 10395, CHICAGO, IL, 60610, US

(73) Assignee: VEHICLE SUSPENSION CONTROL SYSTEM

(21) Appl. No.: 10/360,212

(22) Filed: Feb. 5, 2003

(51) Int. Cl. B60G 17/015

(52) U.S. Cl. 701/37; 280/5.507

(57) ABSTRACT

The present invention provides a controller that is operative to receive body and wheel accelerations from the vehicle. The controller uses the body accelerations to calculate a Heave, Pitch and Roll (HPR) control signal. In addition, the controller uses the wheel accelerations to calculate a wheel control signal. The calculated wheel control signal and the HPR control signal are combined to create a damper control signal. Based on the damper control signal, the controller is able to move a wheel of the vehicle in the appropriate manner to handle various driving conditions.

### FIELD OF THE INVENTION

The present invention relates to a vehicle suspension control system. More particularly, the present invention relates to a method and apparatus for controlling the vehicle suspension system.

### BACKGROUND

Generally, people use automobiles throughout the world to travel to various destinations. These automobiles include shock absorbers or dampers to ensure that the people will have a smooth ride on their way to the destinations. Shock absorbers or dampers receive and take up the shock that would normally be exerted on the wheels of an automobile in order to improve the ride performance of the vehicle.

There are many different types of known dampers developed to improve the ride performance, such as the continuously variable damper. This continuously variable damper has an infinite, or a large number of settings from soft to firm that indicate the level of ride performance that will be experienced by the vehicle. However, this damper may be prone to produce increased harshness in the ride due to “over-controlling” while traveling short distances. In addition, these dampers may be “jerky” or “grabby” due to the control algorithms used to dynamically adjust the damping. This problem has been addressed in previous damper control systems developed to provide a method and apparatus for controlling continuously variable dampers in a manner which provides a high level of ride quality, with good balance, reduced harshness, and without any jerkness.

Such damper control systems may fail to include a wheel-hub mode control, which is needed to control the dynamics of a vehicle for uneven driving conditions, such as bumps and rough roads

Accordingly, there is a need for a method and apparatus that enables a vehicle to provide a good ride performance for a wide variety of driving conditions, including uneven driving conditions.

### BRIEF SUMMARY

One aspect of the present invention provides an apparatus for controlling a damper in a vehicle suspension system. The apparatus includes a controller that is operative to receive body and wheel accelerations from the vehicle; use the body accelerations to calculate a Heave, Pitch and Roll (HPR) control signal; and use the wheel acceleration to calculate a wheel control signal for the damper. The calculated wheel control signal and the HPR control signal are combined to create a damper control signal. Based on the damper control signal, the controller is able to move a wheel of the vehicle in the appropriate manner to handle various driving conditions.

Another aspect of the present invention provides a method for controlling dampers in a vehicle suspension system. Body accelerations from the vehicle are received. A Heave, Pitch and Roll (HPR) control signal for the damper is calculated based on the received body accelerations. Wheel accelerations from the vehicle are received. A wheel control signal for the damper is calculated based on the received wheel acceleration. The calculated wheel control signal and the HPR control signal are combined to create a damper control signal. The damper of the vehicle is adjusted based on the damper control signal.

Each of the aforementioned inventions provide the advantage of enabling a vehicle to provide a good ride performance for a wide variety of driving conditions, including uneven driving conditions.

These and other advantages of the present invention will become more fully apparent as the following description is read in conjunction with the accompanying drawings.

### BRIEF DESCRIPTION OF THE DRAWINGS

FIG. 1 schematically illustrates an embodiment of a vehicle that includes a controller and sensors according to a present invention;

FIG. 2 schematically illustrates an embodiment of the controller, sensors and dampers to be used with the vehicle of FIG. 1 according to the present invention;

FIG. 3 depicts a block diagram of an embodiment of a wheel-hub mode control system process according to the present invention;

FIG. 4 depicts graphic illustrations of possible vehicle body heave accelerations used with a comparison of the embodiment of FIG. 1 and a known damper system;

FIG. 5 depicts graphic illustrations of possible vehicle body pitch accelerations used with a comparison of the embodiment of FIG. 1 and a known damper system;

FIG. 6 depicts graphic illustrations of possible vehicle body roll accelerations used with a comparison of the embodiment of FIG. 1 and a known damper system;

FIG. 7 depicts graphic illustrations of possible front left wheel vertical accelerations used with a comparison of the embodiment of FIG. 1 and a known damper system;

FIG. 8 depicts graphic illustrations of possible front right wheel vertical accelerations used with a comparison of the embodiment of FIG. 1 and a known damper system;

FIG. 9 depicts graphic illustrations of possible rear left wheel vertical accelerations used with a comparison of the embodiment of FIG. 1 and a known damper system; and

FIG. 10 depicts graphic illustrations of possible rear right wheel vertical accelerations used with a comparison of the embodiment of FIG. 1 and a known damper system.

### DETAILED DESCRIPTION OF THE PRESENT INVENTION

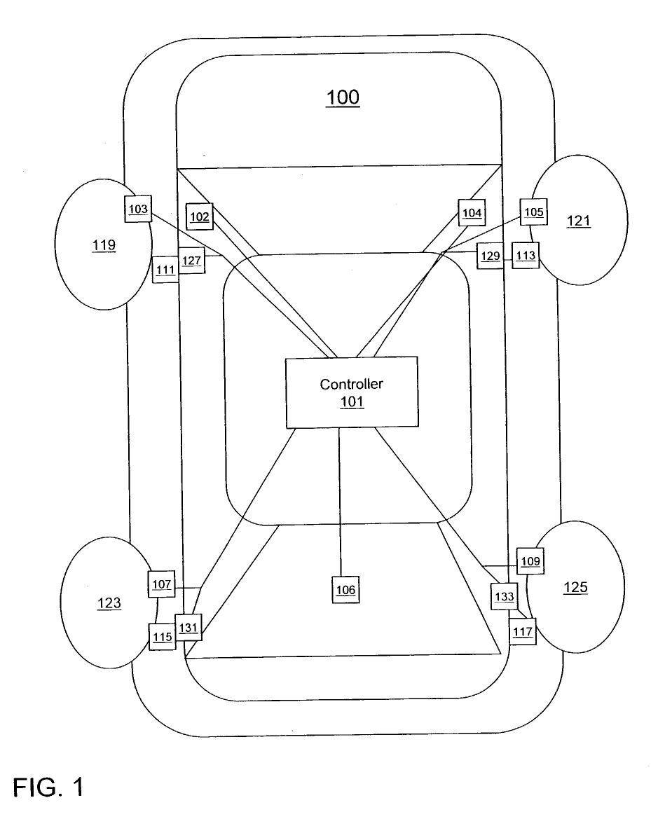

As shown in FIG. 1, vehicle 100 includes: a controller 101, accelerometers 102, 104 and 106 (102-106), sensors 103, 105, 107 and 109 (103-109), dampers 111, 113, 115 and 117 (111-117), power electronics 127, 129, 131 and 133 (127-133), wheels 119, 121, 123 and 125 (119-125) and the typical components associated with a vehicle. Controller 101 is coupled to accelerometers 102-106, sensors/accelerometers 103-109 and power electronics 127-133. Accelerometers 102 and 104 are located closed to respective wheels 119 and 121. Accelerometer 106 is located in a back portion of vehicle 100. Sensors 103-109 are located on the respective wheels 119-125 of the vehicle 100. Power electronics 127-133 are coupled to the dampers 111-117. Dampers 111-117 are further coupled to the respective wheels 119-125. A cable, wire connection or any type of connection used to connect electrical devices couples the controller 101 to the accelerometers 102-106, sensors 103-109, power electronics 127-133 and dampers 111-117. In addition, the cable or wire connection is utilized to couple the dampers 111-117 to the respective wheels 119-125.

Turning to the operation of the controller 101, it receives body accelerations and vertical wheel accelerations from accelerometers/sensors 102, 104 and 106 (102-106) on the body and accelerometers/sensors 103-109 located on wheels 119-125. Body accelerations are received from accelerometers/sensors 102-106. These body accelerations are converted to heave, pitch and roll accelerations. Heave is a vertical acceleration calculated from the center of gravity of the vehicle 100 body where positive heave acceleration is directed downward. Pitch is the angular acceleration of vehicle 100 measured in rad/s² where the positive pitch acceleration is calculated at the front of the vehicle 100 body being directed upward. Roll is the angular acceleration of the vehicle 100 measured in rad/s² where the positive roll acceleration is at the left side of the vehicle 100 body being directed upward. Vertical wheel acceleration is a linear acceleration of the wheels 119-125 measured in m/s² taken from sensor/accelerometers 103, 105, 107 and 109. This vertical wheel acceleration is not related to the translation acceleration caused by the rotation of the wheels of the tire, this wheel acceleration is related to the linear up and down acceleration of the wheels 119-125.

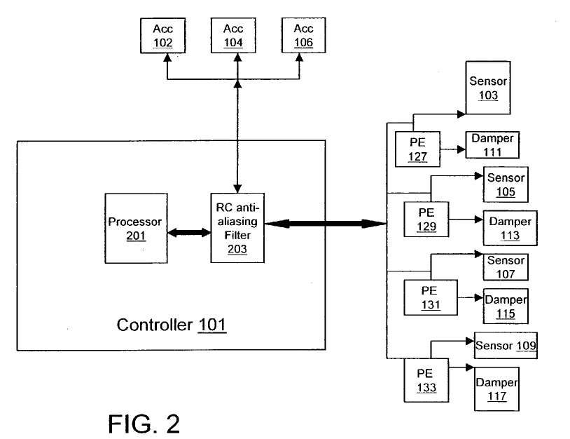

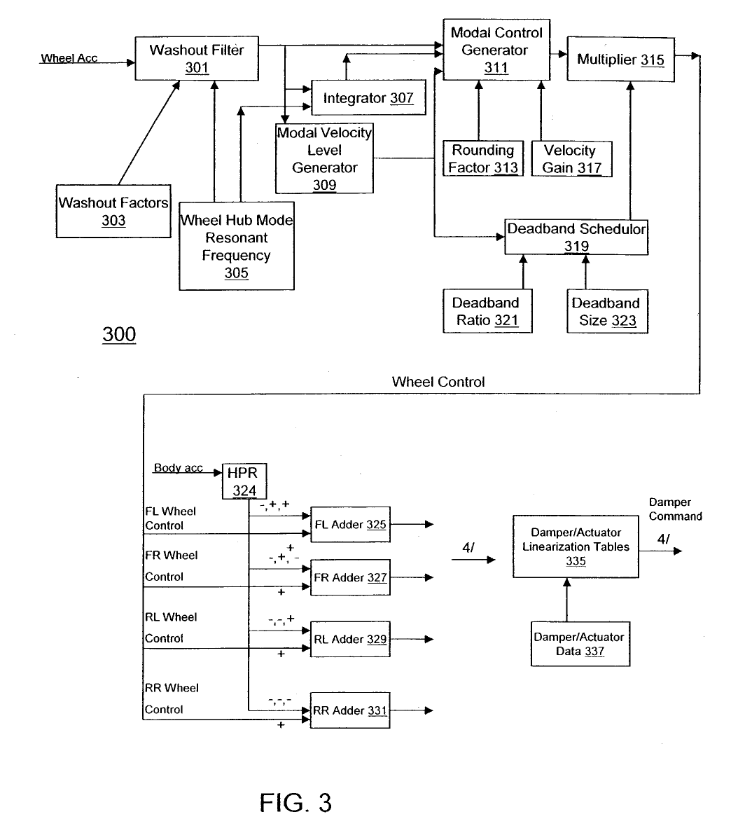

Controller 101 uses the aforementioned accelerations from sensors 103-109 in a control system process described in FIGS. 2 and 3 to direct the vertical movement or acceleration of the wheels 119, 121, 123 and 125 (119-125). For example, when the controller 101 uses the control system process of FIG. 3 it is able to make shock absorbers or dampers 111, 113, 115 and 117 (111-117) move to control the vertical acceleration of wheels 119-125. Controller 101 directs the movement of wheels 119-125 to improve the ride performance of the vehicle 100.

As shown in FIG. 2, controller 101 receives body accelerations from accelerometers 102-106. In addition, controller 101 receives vertical wheel accelerations from sensors 103-109. When the controller 101 receives these body and vertical wheel accelerations it inputs them into a processor 201. Processor 201 includes the control system process, described in FIG. 3, which uses the vertical wheel acceleration to control dampers 111-117 that controls the vertical acceleration of wheels 119-125. In addition, processor 201 uses the body accelerations from accelerometers 102, 104 and 106 in the control algorithm disclosed in U.S. Pat. No. 5,864,768 in Heave, Pitch and Roll block 324, incorporated by reference herein to also use the dampers 111-117 to control the wheels 119-125.

Turning to the components of controller 101, it includes the processor 201 and a typical RC anti-aliasing filter 203. This RC anti-aliasing filter 203 is a known filter that ensures clean and proper signals are measured from the sensors 103-109 by the processor 201. In addition, the RC anti-aliasing filter 203 improves the sensing information from accelerometers 102, 104 and 106 and sensors 103, 105, 107 and 109 before their signals are converted from analog to digital signals at processor 201. When processor 201 receives the signals from the RC anti-aliasing filter 203 it converts them to digital signals or accelerations, then the processor 201 inputs these signals into the control system process of FIG. 3 and the control algorithm of U.S. Pat. No. 5,864,768 to control the movement of dampers 111, 113, 115 and 117 (111-117). Processor 201 utilizes the accelerations with the control system process of FIG. 3 and the control algorithm of U.S. Pat. No. 5,864,768 to formulate commands transmitted to the power electronics 127, 129, 131 and 133 (127-133) to control the dampers 111-117. The dampers 111-117 are utilized by processor 201 to control the wheel movement or vertical wheel acceleration of wheels 119, 121, 123 and 125 (119-125).

Processor 201 may have many forms, for example, processor 201 can be implemented as a hardware device integrated with the control system process of FIG. 3, the control algorithm of U.S. Pat. No. 5,864,768 and a software algorithm. Preferably, this hardware device includes microprocessors, micro-controllers, or digital signal processors, having an electronic erasable program read only memory (EEPROM) or Flash memory, static random access memory (RAM), a clocking/timing circuit, or any typical processor utilized in an electrical device. The software algorithm in processor 201 enables this processor to continuously monitor and read signals from accelerometers 102-106 and sensors 103, 105, 107 and 109 (103-109). Processor 201 also includes the control system process of FIG. 3 and the control algorithm of U.S. Pat. No. 5,864,768 to transmit a pulse width modulated signal to power electronics 127-133 to move dampers 111-117. Dampers 111-117 control the vertical wheel movement of wheels 119-125. Processor 201 is coupled to the power electronics 127-133.

Power electronics 127-133 receive commands from processor 201 to move dampers 111-117 that control the vertical movement of wheels 119-125. The power electronics 127-133 include the typical components utilized to drive a circuit. Preferably, the power electronics 127-133 include four-closed loop current controllers (or solenoid valves) or stepper motor drivers to move the dampers 111, 113, 115 and 117, which move the wheels 119-125 (FIG. 1). Next to the power electronics 127, 129, 131 and 133 (127-133) are the sensors 103, 105, 107 and 109 (103-109).

Sensors 103, 105, 107 and 109 are typical accelerometers/sensors. These accelerometers measure the up and down linear acceleration of wheels 119, 121, 123 and 125.

Next to the wheel sensors 103-109 and wheels 119-125 (FIG. 1) are dampers 111-117. Dampers 111-117 receive commands or instructions from the power electronics 127-133 to move the wheels 119-125. Dampers are also known as shock absorbers. Shock absorbers receive and take up shock that would normally be exerted on the wheels of a vehicle in order to improve ride performance. There are different types of shock absorbers such as multi-stage shock absorbers and continuously variable shock absorbers. The multi-stage shock absorbers have three settings: soft, firm and intermediate settings, which indicate the level of vehicle ride performance experienced by the passengers. Continuously variable shock absorbers or continuously variable dampers have a large number of settings between soft and firm. In addition, some continuously variable shock absorbers may be referred to as “skyhook dampers”, because the shock absorbers simplify the implementation of a control system that controls a ride base on the skyhook theory.

FIG. 3 depicts a block diagram of a wheel-hub mode control system process. This control system process 300 is stored on processor 201 (FIG. 2). Processor 201 receives vertical wheel accelerations from accelerometers/sensors 103, 105, 107 and 109 (103-109), which are inputted into the control system process 300. In addition, processor 201 receives sensor signals from accelerometers 102, 104 and 106 that are converted to heave, pitch and roll accelerations by the control algorithm in Heave, Pitch and Roll block 324. This control algorithm is from U.S. Pat. No. 5,864,764, which is incorporated by reference herein.

A first portion of the control system process 300 includes a washout filter block 301 that receives the vertical wheel acceleration signals from the sensors 103-109 for wheels 119 (front left), 121 (front right), 123 (rear left) and 125 (rear right). In addition, the washout filter block 301 receives a washout factor block 303 as a tuning parameter and a wheel hub mode resonant frequency block 305. Preferably, the washout factor block 303 has a frequency below 0.5 Hz. Washout filter block 301 is a separate high pass filter applied to each of the signals of vertical wheel accelerations to remove low frequency components, including direct current (“DC”) components, from each acceleration or signal.

Turning to the wheel hub mode resonant frequency block 305, this block 305 is a constant value, which usually has a frequency that ranges from 10 to 12 Hz. This frequency depends on the approximate tire stiffness of wheels 119, 121, 123 and 125 (119-125) and an unsprung mass. The unsprung mass mode frequency is derived from the wheel stiffness or tire stiffness of wheels 119-125 and an unsprung mass. Unsprung mass includes wheels and tires, brake assemblies, the rear axle assembly and other structural members not supported by springs of vehicle 100.

When the vertical wheel accelerations pass through the washout filter block 301, then these accelerations are transmitted to an integrator block 307, a modal velocity generator block 309 and a modal control generator block 311. At the integrator block 307, each vertical wheel acceleration for wheels 119-125 is integrated to yield an actual modal velocity. At the modal velocity generator block 309, velocity levels or modal_vel_level value is calculated for each vertical wheel acceleration signal. Considering resonant (oscillatory) wheel motion in each mode, this signal represents the amplitude of the sinusoidal velocity. The integrator block 307 and modal velocity generator block 309 each receives a frequency from the wheel hub mode resonant frequency block 305.

In order to calculate the velocity level, each vertical wheel acceleration is first divided by the mode frequency from the wheel hub mode frequency block 305 to obtain a first value. For example the first value for the front left wheel acceleration is calculated by dividing the front left wheel acceleration by the value in the mode frequency block 305 in the following equation:

Front Left wheel acceleration/wheel hub mode frequency=1^{st} value

The first values for front right (FR) wheel acceleration, rear right (RR) wheel acceleration and rear left (RL) wheel acceleration are determined in a similar manner. Next, each vertical wheel acceleration is integrated around the mode frequency region of wheel hub mode frequency block 305 to produce second values for the wheel accelerations. For example, in order to calculate the second value or an integrated value for the front left wheel acceleration, the front left wheel acceleration is transmitted through a typical integration filter in the mode frequency range of mode frequency block 305. Further, the first and second values are squared and added together, then their combined value is square rooted to generate the velocity level as shown in the following equation:

[(Front Left Wheel Acc/wheel hub mode freq)²+(integrated acc value²)]^{1/2}=velocity level for front left wheel

The velocity levels for front right wheel, rear left wheel and rear right wheel accelerations are calculated in a similar manner. This is only one example of how the velocity levels are calculated. There are also other well-known methods for calculating the velocity levels.

Turning to the Heave, Pitch and Roll (HPR) block 324, this block represents the control algorithm of U.S. Pat. No. 5,864,768 incorporated by reference herein, which is stored in processor 201 of controller 101. The accelerations are received from accelerometers 102-106 and converted to the Heave, Pitch, Roll (HPR) control signal or control signal at controller 101 for each damper 111, 113, 115 and 117 according to the following equation:

$$HPR Control = {G}_{Vel} \cdot \frac{vel \cdot ( 1 + rf )}{\frac{\vert vel \vert}{vel\_level} + rf} \cdot {ⅇ}^{( {G}_{acc} \cdot sign ( vel ) \cdot acc )}$$

where: HPR control is the modal control signal for the respective heave, pitch or roll acceleration

G_{Vel} is the modal velocity gain from the velocity gain block 317 (tuning parameter);

vel is the modal velocity (from the integrator block 307);

rf is a rounding factor 313 (tuning parameter);

vel_level is the modal velocity level from the modal velocity generator block 309;

G_{acc} is the modal acceleration gain (tuning parameter) that is an acceleration gain block disclosed in U.S. Pat. No. 5,864,768; and

acc is the modal acceleration. This HPR control signal or control signal is used for the primary ride control of vehicle 100.

Turning to the modal control generator block 311, it receives wheel acceleration signals from the washout filter block 301, from the integrator block 307 and from the modal velocity level generator block 309. The modal control generator block 311 calculates a wheel control signal for each damper 111-117 according to the following equation:

$$Wheel Control = - {G}_{Vel} \cdot \frac{vel ( 1 + rf )}{\frac{\vert vel \vert}{vel\_level} + rf}$$

where: wheel control is the modal control signal for each damper 111-117

−G_{Vel} is the modal velocity gain from the velocity gain block 317 (tuning parameter);

vel is the modal velocity (from the integrator block 307);

rf is a rounding factor 313 (tuning parameter); and

vel_level is the modal velocity level from the modal velocity generator block 309.

This wheel control signal is used for the secondary ride control to improve the ride performance of vehicle 100. The control signal and wheel control signal are combined to create a damper control signal.

The modal control generator block 311 receives a rounding factor block 313 and a velocity gain block 317 as tuning parameters.

Turning to the deadband schedulor block 319, the purpose of this block is to normalize the modal velocity level from the vertical wheel accelerations as a value between 0 and 1. Deadband_schedulor block 319 is calculated for wheel acceleration for wheels 119, 121, 123, 125 (119-125) based on a modal_vel_level calculated from modal_velocity generator block 309. Deadband scheduler block 319 receives information from deadband ratio 321 and deadband size 323. Deadband ratio 321 is a known slope rate associated with each automobile. This deadband ratio 321 is used to rescale the damper control signal. Deadband size 323 referred to as a deadband width is a known value for each automobile determined by vehicle suspension tuning.

In the operation of the deadband scheduler block 319, the following equation is utilized:

deadband_schedulor block 319=deadband_ratio 321*(modal_vel_level−deadband_width 323).

This deadband_schedulor block 319 receives a modal_vel_level from modal velocity level generator block 309 and uses it in the above-referenced equation. In an example utilizing the equation, if the modal_vel_level value or velocity level, described above, is less than the deadband_width 323, then the output of the deadband_schedulor block 319 will be zero. However, if the modal_vel_level value is more than the deadband_width 323, then the output of the deadband_schedulor block 319 will be between zero and one.

The output from the deadband_schedulor block 319 for the wheel accelerations for wheels 119, 121, 123 and 125 are transmitted to the multiplier block 315, where they are used to multiply the damper control signal from modal control generator block 311 to adjust the damper control signal to create an output control signal. The multiplier block 315 simply multiplies the values of the output from the deadband_schedulor block 319 with the damper control signal, which operates similar to the multiplier block in U.S. Pat. No. 5,864,768, which is herein incorporated by reference. In this manner, the damper control signal is adjusted to the output control signal in accordance with the significance of the ride event occurring.

HPR block 324 receive body accelerations and sends out split HPR control signals for dampers 111, 113, 115 and 117. Next, summation of all the split output control signals and wheel control signal at each of the ADDERs gives the total output control signals for each damper 111, 113, 115 and 117 (111-117). The ADDERs include front left (FL) Adder block 325, front right (FR) Adder block 327, rear left (RL) Adder block 329 and rear right (RR) Adder block 331, which add or subtract the output control signals from the multiplier 315 corresponding to the dampers 111-117.

Each of the ADDERs receive 4 output control signals, which are denoted by a “+” value for a positive input or “−” value for a negative input. The output control signals for each ADDER are combined to create one output control signal for each ADDER. For example, FL Adder block 325 receive the HPR control signals from HPR block 324 that are respectively denoted as “−,+,+” values. The FL Adder block 325 also receives a “+” wheel control signal from multiplier block 315. FL Adder block combines the HPR control signals value with the wheel control signal value for the output control signal value. The FR Adder block 327 receives the HPR control signals from HPR block 324 that are respectively denoted as “−,+,−” values. In addition, the FR Adder block receives the wheel control signal of “+” value from multiplier block 315. FR Adder block combines the HPR control signals value and the wheel control signal value into one value for FR Adder block 327 output control signal.

Next, the RL Adder block 329 receives HPR control signals from HPR block 324 that are respectively denoted as “−,−,+” values. The RL Adder block 329 also receives the “+” value wheel control signal from multiplier block 315. This RL Adder block 329 combines the received HPR control signal value and the wheel control signal value combined into one value for the output control signal. Further, the FR Adder block 331 receives the HPR control signals from HPR block 325 that are respectively denoted as “−,−,−” values. The FR Adder block 331 also receives a wheel control signal with a “+” value from multiplier block 315. The HPR control signal values and the wheel control signal value are combined at the FR Adder block 331, then these values are combined into one value for the output control signal.

Next, the four output control signals from each ADDER are transmitted to the Damper/Actuator linearization tables block 335. The damper/actuator linearization tables block 335 also receives damper/actuator data from damper/actuator data block 337 as calibratable constants. The damper/actuator data block 337 and damper/actuator linearization tables block 335 are known for each automobile that includes semi-active suspension systems. Based on the damper/actuator data block 337, the four output control signals at the Damper/Actuator linearization tables block 335 are re-aligned to create proper control signals as damper commands. This table includes a control mapping strategy to tune the output control signals properly for the corresponding dampers 111, 113, 115 and 117 (111-117) to achieve proper damping level in response to the damper commands so the ride for the front wheels and rear wheels 119, 121, 123 and 125 (119-125) of the vehicle 100 can be improved. The resulting damper commands will be transmitted to the power electronics 127, 129, 131 and 133 (127-133). Preferably, the power electronics 127-133 are four closed loop current controllers (or solenoid valves) or stepper motor drivers, the outputs of which will adjust each respective continuously variable damper 111-117.

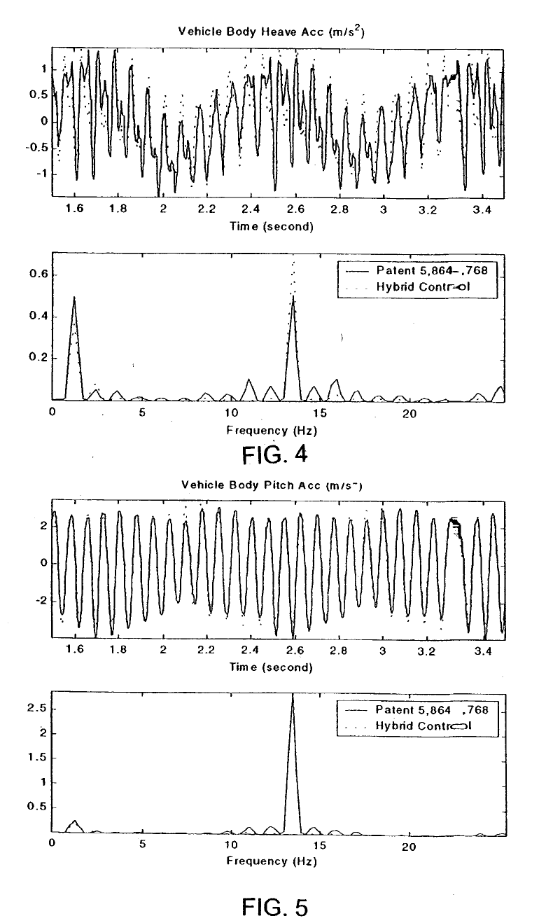

FIGS. 4, 5 and 6 respectfully depict graphic illustrations of possible vehicle body heave, pitch and roll accelerations used with a comparison of the present invention and a known damper system. These accelerations of vehicle 100 body heave, pitch and roll accelerations with respect to time, and frequency are taken from sensors 103-109 and transmitted to processor 201. A solid line on the illustration denotes the output of the vehicle body heave, pitch and roll accelerations associated with the known damper system and the dotted line denotes the vehicle 100 body heave, pitch and roll accelerations of the control system process 300 (FIG. 3). The difference between the vehicle body heave, pitch and roll accelerations associated with the known damper system and the control system process 300 is that the accelerations from the wheels 119-125 (FIG. 1) are significantly reduced for the control system process 300 in comparison with the known damper system. The control system process 300 can be used to reduce body heave, pitch and roll resonant peaks, but it creates a little larger body wheel-hub mode peak than the known damper system.

In FIG. 5, the control system process 300 of FIG. 3 gives a little better control over pitch then the known damper system. For FIG. 6, the control system process 300 gives a little better control over roll than the known damper system.

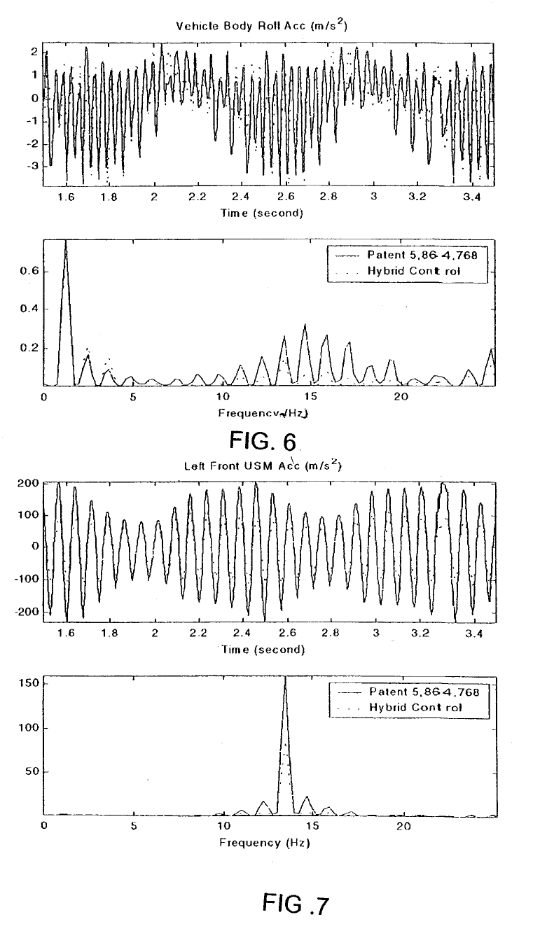

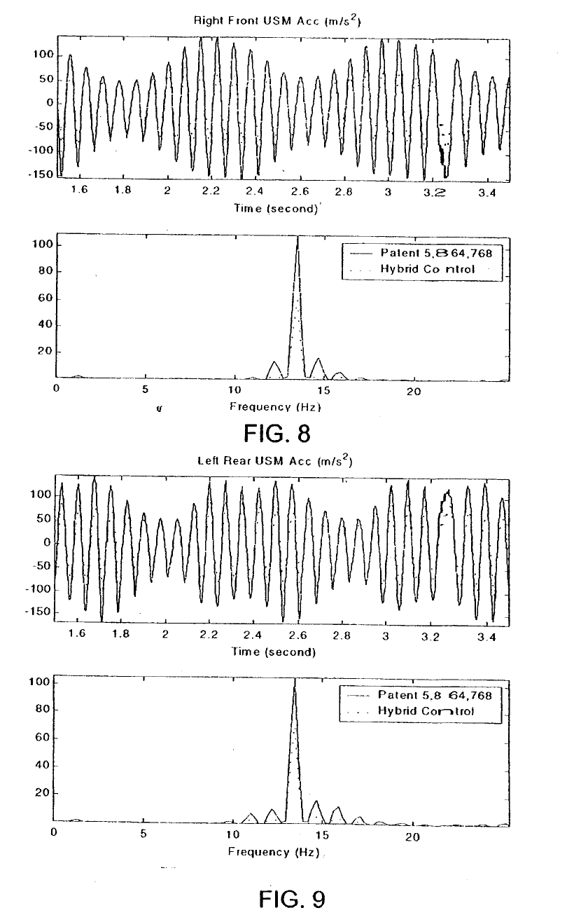

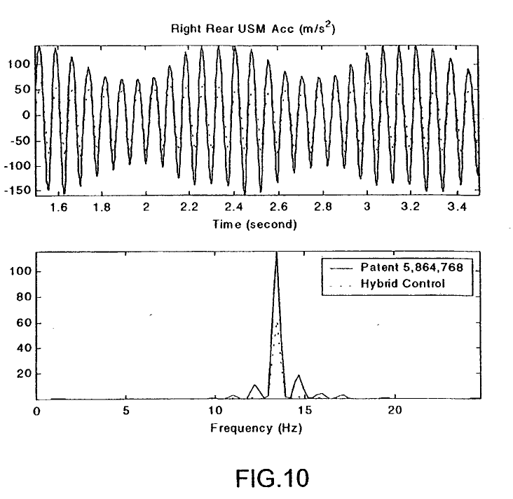

FIGS. 7, 8, 9 and 10 respectively depict graphic illustrations of front left wheel, front right wheel, rear left wheel and rear right wheel accelerations for the known damper system and the control system process of FIG. 3. These illustrations depict front left wheel 119 accelerations (FIG. 7), front right wheel 121 accelerations (FIG. 8), rear left wheel 123 accelerations (FIG. 9) and rear right wheel 125 accelerations (FIG. 10) with respect to time and frequency taken from sensors 103-109, then transmitted to processor 201. A solid line on the illustration denotes the front left wheel, front right wheel, rear left wheel and rear right wheel vertical accelerations associated with the known damper system, and the dotted line denotes the front left wheel, front right wheel, rear left wheel and rear right wheel accelerations associated with the control system process 300 of FIG. 3. For FIGS. 7, 8, 9 and 10 the difference between the front left wheel, front right wheel, rear left wheel and rear right wheel vertical accelerations of the known damper system and the control system process 300 of FIG. 3 is that the accelerations from the wheels 119-125 (FIG. 1) are significantly reduced for the control system process 300 in comparison with the front left wheel, front right wheel, rear left wheel and rear right wheel vertical accelerations of the known damper system. The control system process 300 can better control the wheel acceleration than the known damper system.

From the foregoing, it can be seen that the present invention provides an apparatus and method for controlling a vehicle suspension system. In particular, this invention provides a controller that is operative to receive heave, pitch, roll and wheel accelerations from the vehicle. The controller uses the heave, pitch and roll accelerations to calculate a control signal. In addition, the controller uses the wheel acceleration to calculate a wheel control signal. The calculated wheel control signal and the control signal are combined into a damper control signal. Based on the damper control signal, the controller is able to move the wheels of the vehicle in the appropriate manner to handle various driving conditions. Therefore, this invention provides the advantage of being able to handle various driving conditions, for example bumps and rough roads, so the ride performance of the vehice is improved.

It is therefore intended that the foregoing detailed description be regarded as illustrative rather than limiting, and that it be understood that it is the following claims, including all equivalents, that are intended to define the spirit and scope of this invention.

We claim:

1. A method for controlling a damper in a vehicle suspension system, the method comprising:
receiving body accelerations from a vehicle;
calculating a control signal for a damper based on said received body accelerations;
receiving wheel acceleration from the vehicle;
calculating a wheel control signal for the damper based on said received wheel acceleration;
combining the control signal and the wheel control signal to create a damper control signal; and
adjusting the damper of the vehicle based on the damper control signal.

2. The method of claim 1 wherein the body accelerations comprise heave, pitch and roll accelerations.

3. The method of claim 1 wherein receiving the body and wheel accelerations are received from an RC anti-aliasing filter.

4. The method of claim 3 wherein receiving the body and wheel accelerations from the RC anti-aliasing filter further comprises receiving measurements from a sensor.

5. The method of claim 2 wherein the wheel acceleration comprises vertical wheel acceleration.

6. The method of claim 5 further comprises applying a high pass filter to the vertical wheel accelerations to remove low frequency components from the measurements.

7. The method of claim 6 wherein the low frequency components are direct current components.

8. The method of claim 1 wherein the damper comprise a continuously variable damper.

9. The method of claim 1 wherein the control signal comprises a Heave, Pitch and Roll (HPR) control signal.

10. The method of claim 9, wherein the HPR control signal for the damper is calculated in accordance with the following equation:
$$HPR Control = {G}_{Vel} \cdot \frac{vel \cdot ( 1 + rf )}{\frac{\vert vel \vert}{vel\_level} + rf} \cdot {ⅇ}^{( {G}_{acc} \cdot sign ( vel ) \cdot acc )}$$
where Gᵥₑₗ is a modal velocity gain, vel is a modal velocity, rf is a rounding factor, vel_level is a modal velocity level and G_{acc} is a modal acceleration gain.

11. The method of claim 2, wherein the wheel control signal for the damper is calculated in accordance with the following equation:
$$Wheel Control = - {G}_{Vel} \cdot \frac{vel ( 1 + rf )}{\frac{\vert vel \vert}{vel\_level} + rf}$$
where −G_{Vel} is a modal velocity gain, vel is a modal velocity, rf is a rounding factor and vel_level is a modal velocity level.

12. The method of claim 10, wherein the wheel control signal for the damper is calculated in accordance with the following equation:
$$Wheel Control = - {G}_{Vel} \cdot \frac{vel ( 1 + rf )}{\frac{\vert vel \vert}{vel\_level} + rf}$$

13. A system for controlling a damper in a vehicle suspension system, the system comprising:
a controller;
a plurality of accelerometers coupled to the controller, wherein the plurality of accelerometers are operative to transmit body accelerations to the controller;
a sensor coupled to the controller, wherein the sensor is operative to transmit a wheel acceleration to the controller;
a damper coupled to the controller and a vehicle; and
wherein the controller is operative to receive the body accelerations and the wheel acceleration, calculate a Heave, Pitch and Roll (HPR) control signal in response to receiving the body accelerations for the damper, calculate a wheel control signal in response to receiving the wheel acceleration for the damper, combine the HPR control signal and the wheel control signal to create a damper control signal and adjust the damper of the vehicle based on the damper control signal.

14. The system of claim 12 wherein the body accelerations comprise heave, pitch and roll accelerations.

15. The system of claim 14 wherein the damper comprises a continuously variable damper.

16. The system of claim 14 wherein the damper comprises a shock absorber.

17. A controller for controlling a damper in a vehicle suspension system, the controller comprising:
means for receiving body accelerations and wheel accelerations from a vehicle;
means for calculating a Heave, Pitch and Roll (HPR) control signal for a damper in response to receiving the body accelerations;
means for calculating a wheel control signal for the damper in response to receiving the wheel accelerations;
means for combining the HPR control signal and the wheel control signal to create a damper control signal; and
means for adjusting the damper of the vehicle based on the damper control signal.

18. The controller of claim 17 wherein the body accelerations comprise heave, pitch and roll accelerations.

19. The controller of claim 17 wherein said controller comprises a processor.

20. The controller apparatus of claim 17 wherein said controller comprises a microprocessor.
